(19) United States
(12) Patent Application Publication
(10) Pub. No.: US 2006/0200397 A1
(43) Pub. Date: Sep. 7, 2006

(54) Method for maintaining and providing health savings accounts (HSAs)

(76) Inventors: Carl L. Jasperse, Grand Rapids, MI (US); Gregory D. VandenBosch, Grand Rapids, MI (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/345,166

(22) Filed: Feb. 1, 2006

Related U.S. Application Data
(60) Provisional application No. 60/655,237, filed on Feb. 22, 2005.
(60) Provisional application No. 60/701,574, filed on Jul. 22, 2005.

(51) Int. Cl. G06Q 40/00

(52) U.S. Cl. 705/35

(57) ABSTRACT

A business method for maintaining a Health Savings Account (HSA) (100) by providing availability and more convenient access to HSA funds where an HSA is funded through either employee (101), employer contributions (103), or through an individual line of credit from a qualified financial institution (105). Funds may later be withdrawn from the HSA using either a unique debit card which can draw upon access to the line of credit at the point-of-sale or a written or electronic request for reimbursement.

### CROSS-REFERENCE TO RELATED APPLICATION

Priority for this application is based on U.S. Provisional Patent Application Ser. No. 60/655,237, filed on Feb. 22, 2005, entitled Method for Maintaining and Providing Health Savings Accounts (HSAs) and U.S. Provisional Patent Application Ser. No. 60/701,574, filed on Jul. 22, 2005, also entitled Method for Maintaining and Providing Health Savings Accounts (HSAs), both assigned to MedDirect, L.L.C.

### TECHNICAL FIELD

The invention relates to a business method for using a health savings account (HSA) and, more particularly, a business method for providing availability and more convenient access to HSA funds.

### BACKGROUND OF THE INVENTION

An HSA is a tax-favored account created by the 2003 Medicare prescription drug law for eligible individuals covered under certain high-deductible health insurance plans (HDHP). It is opened and owned by the individual insured by the HDHP. As seen in prior art FIG. 1, the typical HSA 10 is funded by an employee or an individual, if not part of a group 12 or, if the HDHP is a group plan, can also be funded by an employer 14. Funds from the HSA 10 are typically disbursed either by a check 16 or debit card 18. Employee or individual contributions to the HSA are tax deductible even if an individual does not itemize deductions, while employer contributions are deductible to the business and not taxable to the employee. Total contributions to an HSA are limited by law and are fully vested when contributed. Earnings and capital appreciation on HSA investments grow tax free. Distributions from an HSA are tax free if they are used to pay for qualified medical expenses. Unused HSA funds can be carried forward and used in future years. Current methods which use a debit for HSA disbursements are offered by HSA trustee/custodians as a banking service without employer support Although an individual may have personal credit available as a source for HSA deposits, it is not linked directly to the HSA and advances cannot be repaid through payroll deductions.

Moreover, a significant concern with HSAs relates to the required HDHP. Individuals covered by HDHPs may not have adequate cash available to pay for medical services subject to the high deductible. For 2006, a minimum deductible of $1,050 for single coverage and $2,100 for family coverage is required. This is a particular concern when purchasing prescription drugs or other costly medical services which are subject to the HDHP deductible, but which must be paid for before being dispensed or performed. Thus, the need exists to provide a business method that can be used to provide adequate funds in the HSA for individuals who would otherwise have insufficient cash to pay for services covered under the HDHP.

### SUMMARY OF THE INVENTION

The present invention provides a business method that provides point-of-sale access to HSA funds if inadequate funds are available in the HSA account. The present invention utilizes three primary components namely: 1) an HSA-qualified checking, savings, or investment account at a financial institution; 2) access to HSA funds through a “smart” debit card and requests for reimbursement; and 3) availability of overdraft protection on the HSA through a line of credit. The business method of the invention provides availability and more convenient access to HSA funds, thereby enabling individuals covered by HSA-qualified HDHPs to obtain needed, quality medical care. The invention offers advantages over other business methods utilizing an HSA line of credit in that advances on the credit line are activated by the participant automatically at the point-of-sale through the use of overdraft protection. Alternatively, advances on the line of credit are activated by completing a request for reimbursement.

### BRIEF DESCRIPTION OF THE DRAWINGS

FIG. 1 is a prior art block diagram showing the current business methods using an HSA.

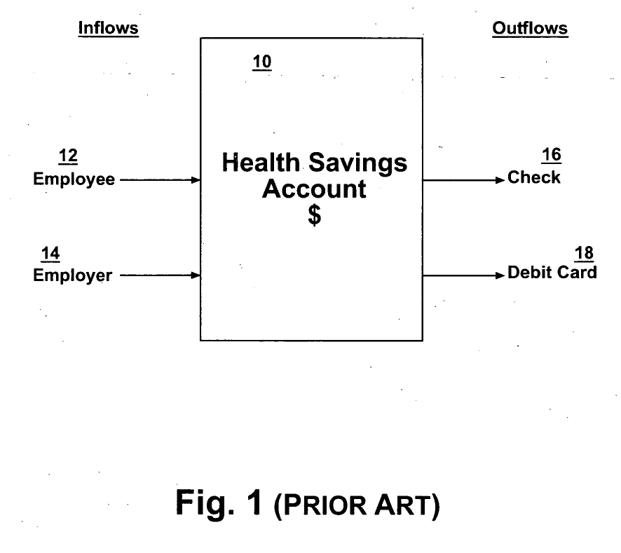

FIG. 2 is a block diagram showing the business method of the present invention where the HSA may be funded using a line of credit with funds dispensed at the point-of-sale through the use of a “smart” debit card or through a request for reimbursement.

FIG. 3 is a block diagram showing the business method of the present invention where the HSA line of credit can be secured by an individual or employer, if a group plan.

### DETAILED DESCRIPTION OF THE PREFERRED EMBODIMENT

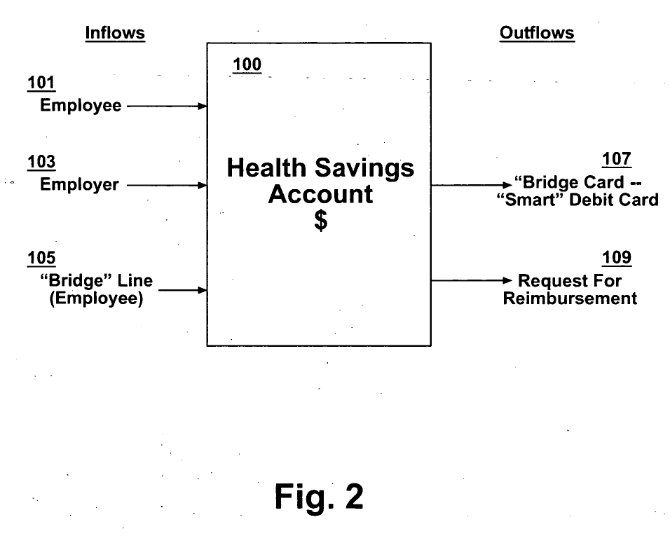

Referring now to FIG. 2, a block diagram showing the preferred business method of the invention includes funding an HSA 100 by an employee or individual 101, employer 103 if a group HDHP or a line of credit 105. The line of credit is an interest-bearing personal loan made to the employee or individual and is funded by a financial institution or other lender that meets appropriate consumer lending requirements. When an individual desires to access funds from the HSA, a “smart” debit card 107 or a request for reimbursement 109 can be used. The “smart” debit card permits only HSA-qualified expenditures to be processed for payment. The “smart” debit card will function at any merchant that accepts Mastercard, VISA, or other payment network cards for HSA-eligible expenses. The request for reimbursement can be used to request withdrawals for any purpose.

As will be evident to those skilled in the art, the line of credit will function as overdraft protection on the HSA account. When the magnetic number of the “smart” debit card is read by a card reader or a request for reimbursement is processed, available funds will first be drawn from the HSA account. If funds in the account are inadequate, an advance on the individual's line of credit will be automatically activated. In real time, these funds will be deposited in the HSA, and all HSA-eligible charges will be paid at the point-of-sale (if using the “smart” debit card) or the request for reimbursement will be honored.

The line of credit will be funded by a financial institution or other lender, or the HSA participant's employer (for group plans). For individual HSA plans, the line of credit will be underwritten and credit granted based on the individual's creditworthiness. For group HSA plans, the employer (or health insurance plan or HSA trustee/custodian) will be required to guarantee the line of credit. However, financial institutions or other lenders funding such lines of credit will limit an employer guarantee, if the employer agrees to certain credit limits, and to deduct minimum required payments from employees' paychecks (including a significant percentage of an employee's final paycheck). Appropriate authorizations must be obtained from the employee prior to any payroll deductions. The employer will fund the credit guarantee in an escrow account or by posting a letter of credit. Alternatively, a fixed fee per employee per month could be paid by the employer to guarantee the line of credit in lieu of funding an escrow account or posting a letter of credit. Thus, with group plans, no credit underwriting of individual employees is done, however, one or more of these alternative funding vehicles are used to control credit risk.

As will be further recognized by those skilled in the art, the sponsoring financial institution or other lender can provide all servicing functions on the individual lines of credit, including documentation, billing through payroll deductions or direct to the borrower, processing payments, and collections. Internet access to account information will be made available to employers, employees, and individuals. Moreover, the financial institution or other lender can generate income by charging fees on line of credit advances such as interest on outstanding line of credit balances, account and transaction fees, and commissions or consulting fees on the HDHPs.

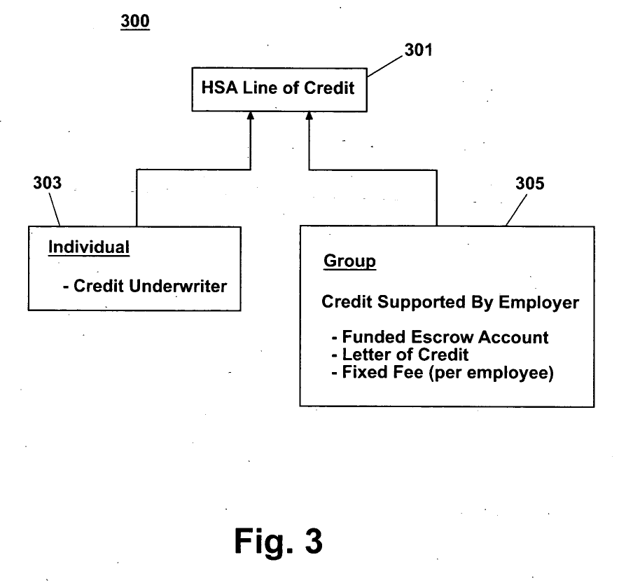

As seen in FIG. 3, the method of securing the HSA line of credit 300 includes by an individual 303, which is performed through a credit underwriting, by a group 305, which is performed through an employer (or other entity) credit guarantee. The employer credit guarantee may be funded either through a fixed fee per employee, posting of a letter of credit, or through a funded escrow account.

Thus, the business method of the present invention is a fully integrated solution where point-of-sale credit is provided from an overdraft line of credit for all HSA-eligible and other expenses. Advances on the line of credit into an individual's HSA in turn create a federal tax deduction for an individual or employee. Moreover, the method provides a unique manner for servicing an employee's HSA loan using minimum required payroll deductions, and for limiting an employer's credit guarantee on the employee line of credit balances.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for maintaining a Health Savings Account (HSA) for providing availability to HSA funds comprising the steps of:
funding an HSA either by individual contributions, employer contributions, or through an individual line of credit from a qualified lender; and
withdrawing funds from the HSA using either a written request for reimbursement or through a unique debit card which can draw upon the line of credit at the point-of-sale.

2. A method for maintaining an HSA as in claim 1, wherein any advances on the line of credit are serviced through minimum required payroll deductions and limiting the employer's credit guarantee for employee line of credit advances.

3. A method for maintaining a Health Savings Account (HSA) for providing convenient access to HSA funds comprising the steps of:
funding an HSA account using personal funds;
withdrawing funds from the HSA through a debit card which can draw upon the individual line of credit at a point-of-sale; and
submitting a written or electronic request for reimbursement.

4. A method for maintaining a Health Savings Account (HSA) for providing a line of credit for medical purposes comprising the steps of:
funding an HSA through individual contributions, employer contributions or through an individual line of credit;
securing the line of credit such that funding for the HSA is substantially guaranteed.

5. A method for maintaining an HSA as in claim 4, wherein the step of securing the line of credit includes the step of:
utilizing credit underwriting for individuals securing the HSA account.

6. A method for maintaining an HSA as in claim 4, wherein the step of securing the line of credit includes the step of:
utilizing an employer guarantee for groups securing the HSA account.

7. A method for maintaining an HSA as in claim 4, wherein a maximum recourse liability of the line of credit is security by a funded escrow account.

8. A method for maintaining an HSA as in claim 4, wherein a maximum credit guarantee of the line of credit is secured by a letter of credit.

9. A method for maintaining an HSA as in claim 4, wherein a maximum credit guarantee of the line of credit is secured by a fixed fee paid by the employer.

10. A method for implementing a Health Savings Account for an account owner comprising:
establishing a Health Savings Account for the benefit of the account owner, wherein funds are periodically deposited into the Health Savings Account;
enabling the account owner to access funds in the Health Savings Account to cover medical expenses incurred by the account owner;
if medical expenses for which the account owner seeks access to funds in the Health Savings Account exceed the amount of funds in the Health Savings Account, automatically depositing borrowed funds into the Health Savings Account sufficient to cover the difference between the medical expenses and the amount of funds in the Health Savings Account; and
enabling the account owner to access the borrowed funds deposited into the Health Savings Account to cover the medical expenses.

11. The method of claim 10, wherein the funds are periodically deposited into the Health Savings Account by the account owner or by the account owner's employer.

12. The method of claim 10, further comprising enabling the account owner to repay the borrowed funds through periodic payroll deductions.

13. The method of claim 10, wherein enabling the account owner to access funds in the Health Savings Account comprises providing the account owner a debit card which draws funds from the Health Savings Account when the account owner uses the debit card to pay for incurred medical expenses at a point of sale.

14. The method claim 13, wherein automatically depositing borrowed funds into the Health Savings Account is initiated when the account owner uses the debit card to pay for incurred medical expenses at a point of sale and there are insufficient funds in the Health Savings Account to cover the incurred medical expenses.

15. The method of claim 10, wherein enabling the account owner to access funds in the Health Savings Account comprises reimbursing the account owner with funds from the Health Savings Account for medical expenses paid for by the account owner upon the account owner submitting a request for reimbursement.

16. The method claim 15, wherein automatically depositing borrowed funds into the Health Savings Account is initiated when the account owner submits a request for reimbursement and there are insufficient funds in the Health Savings Account to cover the requested reimbursement amount.

17. The method of claim 10, wherein depositing borrowed funds into the account comprises funding a line of credit by a commercial lending institution.

18. The method of claim 10, wherein depositing borrowed funds into the account comprises funding a line of credit by the account owner's employer.

19. The method of claim 10, wherein depositing borrowed funds into the account comprises at least one of charging a fixed fee per employee, posting a letter of credit, and funding an escrow account.

20. The method of claim 10, further comprising providing health insurance for the account owner, wherein the Health Savings Account supplements the health insurance to cover medical expenses incurred by the account owner which are not covered by the health insurance.

21. A method for implementing a Health Savings Account for an account beneficiary comprising:
providing a Health Savings Account into which funds are deposited;
enabling an account beneficiary to withdraw funds from the Health Savings Account to cover medical expenses;
providing a line of credit to make additional funds available for withdrawal from the Health Savings Account if medical expenses for which the account beneficiary seeks to withdraw funds from the Health Savings Account exceed the amount of funds in the Health Savings Account; and
enabling the account beneficiary to withdraw from the Health Savings Account the additional funds made available for withdrawal from the line of credit.

22. The method of claim 21, wherein the funds are deposited into the Health Savings Account by the account beneficiary or by the account beneficiary's employer.

23. The method of claim 21, further comprising enabling the account beneficiary to repay the additional funds made available from the line of credit through periodic payroll deductions.

24. The method of claim 21, wherein enabling the account beneficiary to withdraw funds from the Health Savings Account comprises providing the account beneficiary a debit card which draws funds from the Health Savings Account when the account beneficiary uses the debit card to pay for incurred medical expenses at a point of sale.

25. The method claim 24, wherein additional funds are made available for withdrawal from the line of credit when the account beneficiary uses the debit card to pay for incurred medical expenses at a point of sale and there are insufficient funds in the Health Savings Account to cover the incurred medical expenses.

26. The method of claim 21, wherein enabling the account beneficiary to withdraw funds from the Health Savings Account comprises reimbursing the account beneficiary with funds from the Health Savings Account for medical expenses paid for by the account beneficiary upon the account beneficiary submitting a request for reimbursement.

27. The method claim 26, wherein additional funds are made available for withdrawal from the line of credit when the account beneficiary submits a request for reimbursement and there are insufficient funds in the Health Savings Account to cover the requested reimbursement amount.

28. The method of claim 21, wherein providing a line of credit comprises funding a line of credit by a commercial lending institution.

29. The method of claim 21, wherein providing a line of credit comprises funding a line of credit by the account beneficiary's employer.

30. The method of claim 21, wherein providing a line of credit comprises at least one of charging a fixed fee per employee, posting a letter of credit, and funding an escrow account.

31. The method of claim 21, further comprising providing health insurance for the account beneficiary, wherein the Health Savings Account supplements the health insurance to cover medical expenses incurred by the account beneficiary which are not covered by the health insurance.
